(19) United States
(12) Patent Application Publication
(10) Pub. No.: US 2003/0149755 A1
(43) Pub. Date: Aug. 7, 2003

(54) Client-controlled load balancer

(76) Inventor: Emek Sadot, Givatayim (IL)

Correspondence Address: Docket Administration, (Room 1L-202), Avaya Inc., 101 Crawfords Corner Road, P.O. Box 629, Holmdel, NJ, 07733, US

(21) Appl. No.: 10/072,364

(22) Filed: Feb. 6, 2002

(51) Int. Cl. G06F 15/173

(52) U.S. Cl. 709/223

(57) ABSTRACT

A method of selecting a server to represent a virtual server hosted by a plurality of servers. The method includes providing, by a load balancer not associated with the virtual server, values, for one or more parameters, of two or more paths, each path defined between a point in a vicinity of a client accessing the virtual server and one of the plurality of servers representing the virtual server, and selecting a server to provide data for the client, responsive to the values of the one or more parameters.

### FIELD OF THE INVENTION

The present invention relates to data communication networks and in particular to load balancing of packets in data networks.

### BACKGROUND OF THE INVENTION

Web sites hosted by Web servers are commonly used to provide users with information and/or to receive input from users. Users desiring to access a Web site generally indicate, to a program running on a client computer, a Web address of the Web site (e.g., www.avaya.com). The client computer queries a domain name server (DNS) to determine a server IP address (e.g., 10.1.1.100) corresponding to the Web address. The client computer then generally transmits a connection establishment request carrying as its destination address the server IP address received from the DNS server. The Web server responds according to predetermined rules, referred to as protocols, so as to form a connection and provide the requested information.

Some widely used Web sites are hosted by a plurality of Web servers located at different locations, in order to provide fast communication to client computers located in different areas. Each Web server generally has a separate IP address.

When a DNS server receives a query regarding a Web address of a site hosted by a plurality of servers, the DNS server responds with a list of all the IP addresses it is aware of. The client then approaches one of the IP addresses in the list, usually the first in the list. If the first in the list does not respond, the client may approach other servers in the list. In some cases, the DNS server arranges the IP addresses in the list such that a predetermined one of the IP addresses, which is pre-configured in the DNS as being closest to the DNS server, is positioned first in the list. In other cases, the DNS server rearranges the list, for example using the round robin scheme, in order to distribute the traffic between the servers.

In some cases, the owner of a Web site hosted by a plurality of Web servers manages a global server load balancer (GSLB), which determines, for each client request, to which server the client request is to be forwarded. All client requests are initially transmitted to the GSLB, which forwards the packets to the selected servers. GSLBs are described, for example, in “Content Delivery for Distributed Sites”, downloaded from /www.webtechniques.com/archives/2000/12/conn, on Oct. 30, 2001, the disclosure of which is incorporated herein by reference.

The “Distributed Director 2500” series of Cisco, as described in white papers downloaded from /www.cisco.com/univercd/cc/td/doc/product/iaabu/distdir/dd2501/ovr.htm, on Oct. 30, 2001, the disclosure of which documents is incorporated herein by reference, distributes Internet services among topologically dispersed servers. When a client generates a DNS query for a web site handled by the distributed director, the distributed director queries routers near each of the servers for information on the route from the router to the client. The distributed director collects the information from the routers and selects a server to handle the client, accordingly. The distributed director sends the IP address of the selected server to the client in response to the DNS query. The distributed director requires using proprietary routers near each of the servers, as well as a configured DNS server and the director itself, and therefore is available only for a limited number of sites.

### SUMMARY OF THE INVENTION

An aspect of some embodiments of the present invention relates to a client-controlled load balancer (CLB) which provides load balancing services for web sites it is not associated with. In some embodiments of the invention, the client-controlled load balancer is located in the same LAN (i.e., the client and CLB can communicate without passing through a layer 3 router), within a small number of router hops from the client and/or in the same geographical region (e.g., metropolitan, state, country) as the clients it services. Having the load balancer near the client allows for simple evaluation of the path from the client to each of the servers of the web site on which the load balancer operates. Alternatively or additionally, the CLB is configured by the client and/or under the client's instructions. Further alternatively or additionally, the client-controlled load balancer (CLB) is managed by an Internet service provider (ISP) servicing the client. Further alternatively or additionally, the CLB is not under the auspices of either the client or the web site. For example, the CLB may be managed by an ISP servicing an ISP servicing the client. A client-controlled load balancer allows the client to determine how a server is to be selected, rather than having this determination performed by the manager of the web site.

In some embodiments of the invention, the CLB selects a server to represent the web site according to the distances and/or propagation times from the vicinity of the client to the servers. Alternatively or additionally, the CLB selects the server to represent the web site based on the cost of communication between the client and the servers. Further alternatively or additionally, the CLB selects the server to represent the web site based on the quality of the connection between the vicinity of the client and the servers.

Optionally, the CLB manages a list of the Web sites to be handled by the CLB and the respective IP addresses of servers hosting those Web sites. In some embodiments of the invention, for each connection request received by the CLB for a specific handled Web site, the CLB polls a plurality of the servers of the Web site and accordingly selects a server which is currently best for servicing the specific client. Alternatively or additionally, the CLB periodically polls the servers and gathers information on the connections to the servers, such as the round trip delay to the servers, the distance (e.g., number of hops) to the servers, the jitter of the connections to the servers and/or other quality parameters of the connections. In some embodiments of the invention, the CLB also manages preconfigured data on the connections (not determined by polling) such as the communication costs to the servers. The CLB uses the information from the periodic polls to determine to which server to forward connection requests received.

In some embodiments of the invention, the list of Web sites to be handled by the CLB is manually configured by a system manager and/or by the user. Alternatively or additionally, the CLB periodically, and/or upon an update request, receives the list from a central CLB managing site, for example, over the Internet. Further alternatively or additionally, the CLB automatically configures the list according to multiple IP address entries received from DNS servers.

In some embodiments of the invention, the CLB is positioned on a path connecting the client to the Internet, such that substantially all connection requests transmitted from the client pass through the CLB. The CLB intercepts the connection requests and operates accordingly. In some embodiments of the invention, the CLB identifies requests it is to handle by comparing the destination address of the packets it receives to a pre-configured address list of destination Web sites to be handled by the CLB.

The CLB optionally replaces the destination IP address of the connection request with the IP address of the selected server and forwards the connection request to the server. Optionally, the CLB also replaces the IP source address of the connection request and/or one or more other fields of the request. In some embodiments of the invention, the CLB also replaces the destination IP address of all the packets belonging to the established connections. Alternatively or additionally, the CLB notifies the client to which IP address to forward the connection request and does not participate in handling the packets of the connection after establishment of the connection.

In other embodiments of the invention, the DNS servicing the client is configured to return for Web addresses of sites having a plurality of servers with different IP addresses, the IP address of the CLB. The client optionally transmits the connection request to the CLB, without being aware it is a CLB. Thus, only packets which require CLB handling are forwarded to the CLB.

In still other embodiments of the invention, the DNS servicing the client is configured to perform the tasks of the CLB.

In still other embodiments of the invention, the client is configured to transmit connection requests to the CLB. The connection requests are optionally transmitted to the CLB in layer 2. Alternatively, the connection requests are transmitted to the CLB in layer 3 together with the IP address of the web site, or one of the servers of the web site, for example in accordance with a proprietary protocol. Further alternatively, the client connects to the CLB and the CLB determines the site from which the client requires data according to the contents of the application layer data provided by the client.

In some embodiments of the invention, connection requests directed to Web sites hosted by only a single server are forwarded through the CLB without handing by the CLB. Alternatively or additionally, the client transmits to the CLB only packets regarding web sites which require CLB handling. Optionally, the CLB is integrated within a different network element, such as a proxy.

An aspect of some embodiments of the invention relates to a method of selecting a server to represent a site for a client, based on the cost of connecting from the client to the servers representing the site. Optionally, the server selected is the closest server under the constraint that a specific connection of the client to the Internet is used. Alternatively, the server is selected based on a complex function which takes into account the cost of using the connection to the Internet used.

In some embodiments of the invention, the CLB determines, for each server representing the site, for each connection from the client to the Internet, a plurality of connection related parameters, including cost and one or more other quality parameters. Optionally, some of the combinations of servers and connections to the Internet are excluded from being tested as being of no chance or being of very low chances to be selected. In some embodiments of the invention, at least some of the excluded combinations of servers and connections are tested at low rates to determine any changes which may affect their exclusion.

There is therefore provided in accordance with an embodiment of the present invention, a method of selecting a server to represent a virtual server hosted by a plurality of servers, comprising providing, by a load balancer not associated with the virtual server, values, for one or more parameters, of two or more paths, each path defined between a point in a vicinity of a client accessing the virtual server and one of the plurality of servers representing the virtual server, and selecting a server to provide data for the client, responsive to the values of the one or more parameters.

Optionally, the load balancer and the client are in the same metropolitan area and/or the same local area network. Optionally, the one or more parameters comprise at least one of a jitter, a round trip delay or a hop count. Alternatively or additionally, the one or more parameters comprise a cost. Optionally, selecting the server comprises selecting, by a client-controlled load balancer, responsive to receiving identification of a virtual server requested by the client. Optionally, selecting the server comprises selecting, by a client-controlled load balancer, responsive to receiving a connection establishment request from the client.

Optionally, providing the values for the one or more parameters comprises measuring at least one of the parameters. Optionally, measuring at least one of the parameters, for at least one of the paths, is performed before receiving the connection establishment request. Alternatively or additionally, measuring at least one of the parameters for at least one of the paths is performed after receiving the connection establishment request.

Optionally, the method includes changing the destination IP address of packets received by the load balancer from the client, to an IP address of the selected server. Optionally, the method includes changing the source IP address of packets received by the load balancer from the selected server. Optionally, the method includes transmitting an IP address of the selected server to the client. Optionally, transmitting the IP address of the selected server to the client comprises transmitting a DNS response. Optionally, ones of the plurality of servers are located in different geographical regions.

Optionally, selecting a server to provide data for the client comprises selecting, by the load balancer, a second load balancer which is to perform the server selection and selecting, by the second load balancer, a server to provide data for the client. Optionally, the virtual server hosts a web site.

Optionally, selecting a server to provide data for the client comprises selecting a server which minimizes a function of the one or more parameters. Optionally, selecting a server to provide data comprises choosing a function of the one or more parameters to be minimized and selecting a server which minimizes the chosen function. Optionally, the function is chosen responsive to a protocol with which the virtual server is accessed, responsive to the virtual server accessed, responsive to an attribute of the client and/or responsive to the time of the selection.

There is further provided in accordance with an embodiment of the present invention, a method of selecting a server to be accessed, comprising receiving, by a load balancer, a message relating to a virtual server, hosted by a plurality of servers, and to a client desiring to receive data from the virtual server; and selecting, by the load balancer, one of the plurality of servers to provide data to the server, wherein the load balancer is closer to the client than to the selected server.

Optionally, the load balancer is closer to the client than to any of the plurality of servers hosting the virtual server. Optionally, the load balancer is in the same metropolitan area as the client and/or in the same local area network as the client. Optionally, the load balancer is not associated with the virtual server. Optionally, the load balancer is under control of a system manager of the client. Optionally, receiving the message comprises receiving a DNS query message. Optionally, receiving the message comprises receiving from a DNS server. Optionally, receiving the message comprises receiving a connection establishment request directed to the virtual server. Optionally, receiving the message comprises receiving a message directed to the load balancer.

Optionally, selecting one of the servers comprises selecting a server which has a lowest cost path to the load balancer and/or has a lowest delay path or a highest packet size path to the load balancer. Optionally, the load balancer is geographically closer to the client than to the selected server.

There is further provided in accordance with an embodiment of the present invention, a method of selecting a server to be accessed, comprising receiving, by a load balancer, a message relating to a virtual server, hosted by a plurality of servers, and to a client desiring to receive data from the virtual server, and selecting, by the load balancer, one of the plurality of servers to provide data to the client, at least partially responsive to the cost of communications between the client and one or more of the plurality of servers.

Optionally, selecting one of the servers comprises selecting a server under a constraint that a lowest cost client communication connection is used in connecting to the server. Optionally, selecting one of the servers comprises selecting a server which minimizes a weighted sum of communication costs to the server and at least one other route related parameter. Optionally, selecting one of the servers comprises selecting a server which minimizes a weighted sum of the communication costs to the server and the round trip delay to the server.

There is further provided in accordance with an embodiment of the present invention, a load balancer, comprising an interface adapted to receive server access messages from clients, and a processor adapted to determine, for at least one of the messages, whether the message requires load balancing responsive to at least one attribute different from the identity of the server referenced by the message, and to select for at least one message determined to require load balancing, a server to service the client.

Optionally, the at least one attribute comprises the time at which the message is received at the interface, the identity of the client and/or a protocol to govern the communication with the server. Optionally, the load balancer includes a packet changing unit adapted to change the contents of at least one field of packets belonging to connections for which load balancing was performed. Optionally, the packet changing unit is adapted to change packets in accordance with half NAT or fall NAT procedures.

There is further provided in accordance with an embodiment of the present invention, a method of selecting a server to be accessed, comprising receiving, by a load balancer, a message relating to a virtual server, hosted by a plurality of servers, and to a client desiring to receive data from the virtual server, choosing a function from a plurality of predetermined functions utilized by the load balancer for selecting servers, responsive to the received message, and selecting, by the load balancer, one of the plurality of servers that minimizes or maximizes the chosen function, to provide data to the client.

Optionally, choosing the function comprises choosing responsive to an identity of the client and/or a time at which the message is received. Optionally, at least two of the predetermined functions depend on different groups of one or more parameters. Optionally, at least two of the predetermined functions depend on the same parameters but give different weight to one or more of the parameters on which they depend.

### BRIEF DESCRIPTION OF FIGURES

Particular exemplary embodiments of the invention will be described with reference to the following description of embodiments in conjunction with the figures, wherein identical structures, elements or parts which appear in more than one figure are preferably labeled with a same or similar number in all the figures in which they appear, in which:

FIG. 1 is a schematic block diagram of a network in which a client-controlled load balancer (CLB) is used, in accordance with an embodiment of the present invention;

FIG. 2 is a flowchart of the acts performed by a CLB router, in accordance with an embodiment of the present invention;

FIG. 3 is a schematic illustration of an exemplary translation table, in accordance with an embodiment of the present invention;

FIG. 4 is a simplified schematic block diagram of a CLB router, in accordance with an embodiment of the present invention; and

FIG. 5 is a schematic block diagram of a network in which a client-controlled load balancer (CLB) is used, in accordance with another embodiment of the present invention.

### DETAILED DESCRIPTION OF EMBODIMENTS

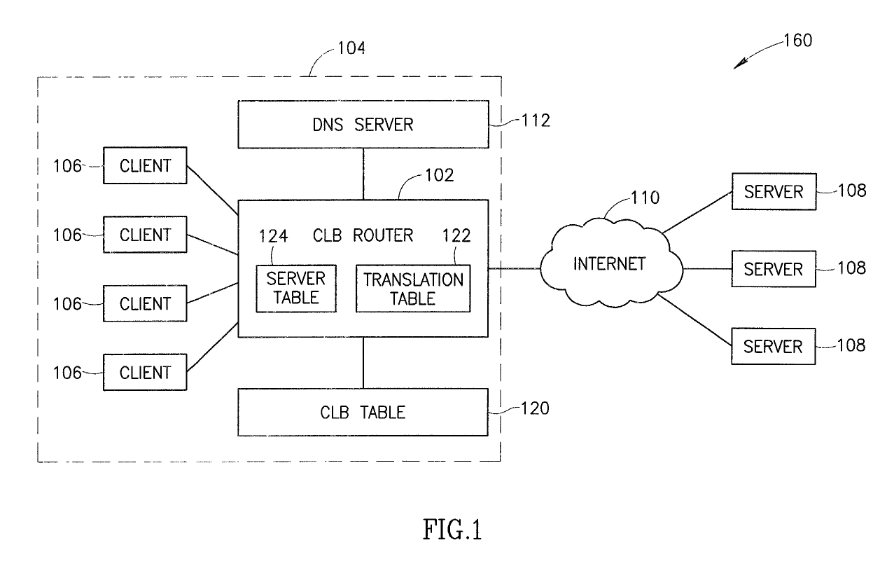

FIG. 1 is a schematic block diagram of a network 160 in which a client-controlled load balancer (CLB) router 102 is used in selecting a server to which to connect, in accordance with an embodiment of the present invention. A client local area network (LAN) 104 includes one or more computers referred to herein as clients 106, which connect to various Web servers over an Internet 110. Some Web sites accessed by clients 106 may be hosted by a plurality of servers 108 identified by different IP addresses, and optionally located in different geographical regions (e.g., in different metropolitan areas, states, countries or continents). CLB router 102 optionally connects clients 106 to the Internet 110. A DNS server 112, optionally included in LAN 104, provides translations for URL addresses to IP addresses, as is known in the art. Alternatively or additionally, LAN 104 does not include a DNS server 112 and, if necessary, a DNS server in Internet 110, external to LAN 104, is used for translating URL addresses to IP addresses.

In some embodiments of the invention, CLB router 102 is closer to client 106 than to any of servers 108. Alternatively, CLB router 102 is closer to client 106 than to any of servers 108, which will be selected to service the client 106, as described hereinbelow. The term closer is used herein in accordance with any distance measure used in the communications field, such as geographical distance, number of router hops or wire link length.

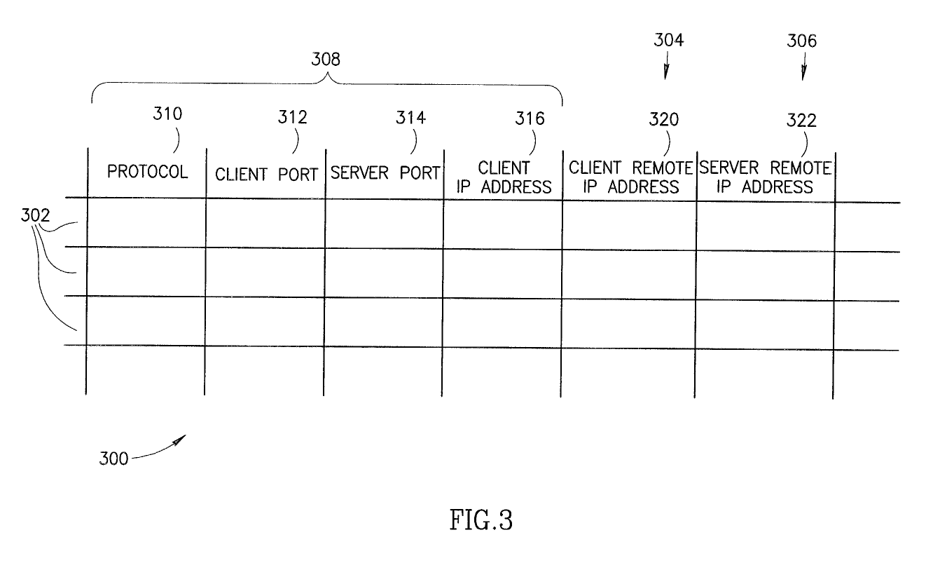

In some embodiments of the invention, CLB router 102 comprises a CLB table 120 which identifies Web sites for which client-controlled load balancing is to be performed. Optionally, CLB router 102 also includes a translation table 122 which carries packet translation information required for changing packets due to client-controlled load balancing, as described hereinbelow with reference to FIG. 3. A server table 124 optionally carries information on the routes to servers 108, which is used in the client-controlled load balancing. The use of tables 120, 122 and 124 is described in detail hereinbelow.

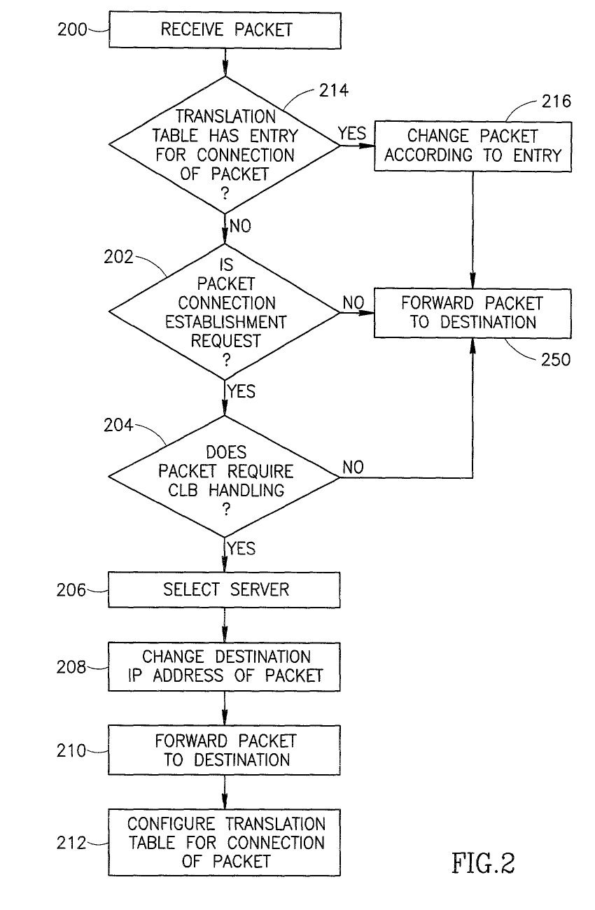

FIG. 2 is a flowchart of the acts performed by CLB router 102, in accordance with an embodiment of the present invention. Upon receiving (200) a packet, CLB router 102 determines whether (214) the table includes an entry for the connection of the packet. If (214) translation table 122 includes an entry relating to the packet, one or more fields of the packet are changed (216) according to the entry. The packet is then forwarded (250) to its destination.

If (214) translation table 122 does not include an entry relating to the packet, CLB router 102 optionally determines whether (202) the packet is a connection establishment request from a client 106. If (202) the packet is a connection establishment request, CLB router 102 determines whether (204) the connection establishment request is directed to a Web site, for which CLB handling is to be provided. If (204) CLB handling is to be provided, CLB router 102 optionally selects (206) a server 108 representing the desired site, based on load balancing and/or optimization considerations, as described below. In some embodiments of the invention, CLB router 102 changes (208) the destination IP address of the request to the IP address of the selected server 108 and forwards (210) the packet to its destination through Internet 110. Optionally, CLB router 102 also configures (212) translation table 122 with an entry for the connection to which the connection establishment request belongs.

If (204), however, CLB handling is not required, the packet is optionally forwarded (250) to its destination without further handling.

Referring in more detail to determining whether (202) a packet is a connection establishment request from a client 106, in some embodiments of the invention, the determination of whether a packet is a connection establishment request is performed based on the ACK and SYN fields of the TCP header of the packet, as is known in the art. Optionally, connection establishment requests from the Internet 110, if such packets are received, are forwarded intact to their destination and are not handled according to load balancing rules.

Referring in more detail to determining whether (204) the connection establishment request is directed to a Web site for which CLB handling is to be provided, in some embodiments of the invention, CLB router 102 manages in CLB table 120, a list of IP addresses of Web sites that warrant CLB handling for packets transmitted to them. Optionally, the list of IP addresses includes for each Web site a representative IP address of the site. Alternatively or additionally, the list of IP addresses includes for at least some of the sites some or all of the IP addresses of the servers carrying the site.

In some embodiments of the invention, the determination of whether to perform CLB handling depends solely on the destination IP address of the packet. Alternatively, one or more other parameters are used in addition to, or instead of, the destination IP address in determining whether to perform CLB handling. For example, in some embodiments of the invention, different clients 106 receive different CLB handling. Optionally, one or more clients 106 receive CLB handling for all Web sites for which CLB handling is useful, while other clients 106 receive CLB handling only for a sub-group of sites or for no sites at all. For example, certain client computers that service workers who require web access for their work are provided CLB handling, while other clients do not receive CLB handling. The clients are identified, for example, according to their IP address and/or the sub-net to which they belong. Alternatively or additionally, the list of sites for which CLB handling is performed depends on the time, date, the traffic load of LAN 104 and/or on any other related parameter.

In some embodiments of the invention, only packets belonging to certain protocols (e.g., http, ftp) receive CLB handling. In some embodiments of the invention, the determination of whether to provide CLB handling for a certain packet depends on the load on CLB router 102, for example according to the percentage of space utilized in a memory carrying entries of translation table 122.

Optionally, CLB table 120 is configured by a system manager. Alternatively or additionally, CLB table 120 is automatically configured whenever a DNS response with more than one IP address is received. Further alternatively or additionally, a CLB maintenance server (not shown) located, for example, in Internet 110, periodically transmits table updates to CLB router 102. The maintenance CLB server may be manually updated based on input from site venders and/or using any other method known in the art.

In some embodiments of the invention, server table 124 includes for each web site which warrants CLB handling for packets directed to the web site, information related to the communication routes between LAN 104 and each of servers 108 hosting the web site. The communication information may include, for example, the round trip delay of the route, the communication cost of the route, the length (e.g., number of hops) of the route, the congestion level of the route, the jitter of the route, the maximal packet size of the route and/or the packet loss rate of the route. Optionally, CLB router 102 selects a server 108 whose path minimizes a function which depends on one or more of the communication information parameters. In an exemplary embodiment of the invention, CLB router 102 minimizes a weighted sum of a plurality of parameters, e.g., of the cost and response time of the route. In other embodiments of the invention, the function involves choosing a server 108 that minimizes one or more parameters, from those servers which have at least a threshold value for one or more other parameters. Optionally, the minimized function depends on the protocol used and/or on the contents of the data being transmitted. For example, the function for sites which provide real time audio or video data optionally give more weight to the jitter and packet loss ratio, while the function for sites which provide bulk data optionally give higher weight to cost.

In some embodiments of the invention, network 160 comprises a plurality of connections to Internet 110. Optionally, the different connections have different cost schedules. For example, the different connections may lead to different sides of the world and may incur charges according to the time of day at the geographical area to which the connections lead. The connections may be managed by the same service provider or by different service providers. The communication costs associated with a server 108 are optionally determined based on the costs of the connection with the shortest path to the server. Alternatively, server table 124 includes for each server 108 a plurality of records corresponding to the plurality of connections to the Internet 110. Rather than selecting a server 108 which minimizes a predetermined function, CLB router 102 selects a combination of a server 108 and a connection to the Internet which minimizes the function. In some embodiments of the invention, some of the combinations of servers 108 and connections do not have entries in table 124 due to their probability of being chosen being very slight or are tested at a much lower late until their probability of being chosen substantially increases.

In some embodiments of the invention, for simplicity of operation, the same function is used for all the web sites for which CLB handling is performed. Alternatively, different functions are used for different web sites. For example, a server for a Web site which incurs large communication costs (e.g., due to large transmission amounts) may be selected primarily according to costs, while a server for a web site which requires a fast response time (e.g., a site which involves fast page changing) may be selected primarily based on response time. Optionally, the function used in selecting the server 108 depends on one or more other parameters, such as the time, date, client identity and/or network congestion. For example, high priority clients 106 may receive selections which disregard costs, while low priority clients 106 receive servers 108 selected with substantial weight given to costs.

In some embodiments of the invention, the information used in selecting the server is predetermined information from server table 124, such that CLB router 102 does not incur a delay to the packet while waiting for the communication information. Optionally, server table 124 is continuously and/or periodically updated. The selection is optionally performed based on the data in table 124 when the packet for which the selection is performed, is received. Optionally, CLB router 102 periodically polls each of servers 108 in order to fill in the communication information of the routes to servers 108, in server table 124. The polling may be performed, for example, every 5-20 seconds, although any other polling rate may be used. Alternatively or additionally, CLB router 102 receives information updates from neighboring network elements and/or from a CLB maintenance server. Further alternatively or additionally, at least some of the communication information is configured manually by a system manager. Alternatively, at least some of the information used in selecting server 108 is determined after the packet is received, optionally responsive to the contents of the packet, such that the selection is performed based on up to date information. In some embodiments of the invention, information determined after receiving the packet is used only in some cases, for example for specific clients 106 and/or for specific web sites, while in other cases, predetermined information from server table 124 is used.

Alternatively to determining whether (214) translation table 122 includes an entry relating to the packet before determining whether (202) the packet is a connection establishment request, CLB router 102 first determines if the packet is a connection establishment request. In this alternative, only if the packet is not an establishment request does CLB router 102 determine whether (214) the translation table 122 includes an entry relating to the packet. In some embodiments of the invention, in accordance with this alternative, CLB router 102 determines whether the client recently connected to the site before selecting the server 108. If the client recently connected to the site, CLB router 102 selects the same server 108 as was previously selected for the client. Optionally, the time between connections of a client which are considered recently is configured by a system manager of the client. Alternatively or additionally, a predetermined default value is used. In an exemplary embodiment of the invention, a client is considered as have connected recently if the subsequent connection is within 5-30 minutes from the previous connection, although any other time interval may be used. Alternatively, for simplicity, CLB router 102 does not relate to whether the client recently connected to the site.

FIG. 3 is a schematic illustration of an exemplary translation table 300, in accordance with an embodiment of the present invention. Table 300 includes, for each connection which requires bi-directional translation due to CLB translation, an entry 302, which includes one or more identification fields 308 that do not change in the translation and can be used to identify packets belonging to the connection. Each entry 302 further includes one or more client fields 304 that identify the connection as recognized by the client and one or more server fields 306 that identify the connection as recognized by the server. In an exemplary embodiment of the invention, the identification fields 308 include a client IP address field 316. Alternatively or additionally, the identification fields 308 include a client port field 312, a protocol field 310 and/or a server port field 314. Including only client IP address field 316 in the identification fields 308, assures that all packets from the same client will be provided to the same sever 108. When identification fields 308 include client IP address field 316 and server port field 314, assures that all packets from the same client directed to the same application of the site will be directed to the same server. By using additional fields, however, a better distribution of the packets between the different servers 108 may be achieved.

Optionally, client fields 304 include a client remote IP address field 320, which states the IP address used by the client for the Web site. Server fields 306 optionally include a server remote IP address field 322, which states the IP address of the selected server 108.

In determining whether (214) translation table 122 includes an entry for a received packet, CLB router 102 optionally differentiates between packets received from clients 106 and packets received from servers 108. For packets received from clients 106, CLB router 102 optionally compares the values of the fields of the packet to identification fields 308 and client fields 304. Since the packet is transmitted from a client 106, the source IP address of the packet is compared to client IP address field 316, and the destination IP address of the packet is compared to client remote IP address field 320. The source and destination port fields and the protocol field of the packet are compared, respectively, to client port field 312, server port field 314 and protocol field 310. If a match is found for all five compared fields, CLB router 102 changes (216) the contents of the IP destination address field of the packet to the value in server remote IP address field 322, of the entry 302 matching the packet. The changed packet is then forwarded to the server 108.

For packets received from servers 108, CLB router 102 optionally compares the values of the fields of the packet to identification fields 308 and server fields 304. Since the packet is transmitted from a server 108, the destination IP address of the packet is compared to client IP address field 316, and the source IP address of the packet is compared to server remote client IP address field 322. The destination and source port fields of the packet are compared, respectively, to client port field 312 and server port field 314. The protocol field is compared to protocol field 310. If a match is found for all five compared fields, CLB router 102 changes (216) the contents of the IP source address field of the packet to the value in client remote IP address field 320, of the entry 302 matching the packet. The changed packet is then forwarded to the client 106. Alternatively, packets received from servers 108 are not changed, under the assumption that client 106 will ignore the unexpected source IP address.

Optionally, CLB router 102 differentiates between packets received from servers and packets received from clients according to the physical port through which the packets are received. In an exemplary embodiment of the invention, the physical port through which the packet is received affects the VLAN of the packet and CLB router 102 examines the VLAN field of the packet. Alternatively or additionally, a VLAN value tagged to the packet by a different router in network 160 is used to determine the origin of the packet. Further alternatively or additionally, CLB router 102 differentiates between packets received from servers and packets received from clients according to the source and/or destination MAC and/or IP addresses of the packets.

In some embodiments of the invention, CLB router 102 changes more than one field of the transmitted packets. For example, in addition to changing the remote IP address, CLB router 102 optionally changes the remote port. Alternatively or additionally, CLB router 102 changes the client IP address and/or the client port. These changes may be performed, for example, using standard Half-NAT and/or Full-NAT methods known in the art. In some embodiments of the invention, CLB router 102 masquerades as the destination server and forms a TCP connection with the client 106. In some of these embodiments, the Web address requested by the client, which appears in the application layer data of the client messages, may be used in addition to, or instead of, the destination IP address, in determining the site requested by the client. After selecting a server 108, CLB router 102 forms a connection with the selected server 108 and splices the connections. Alternatively or additionally, CLB router 102 manages pre-established connections with one or more servers 108, and responsive to receiving a client request uses one of the pre-established connections, as described in U.S. patent application Ser. No. 09/793,455, filed Feb. 26, 2001, the disclosure of which is incorporated herein by reference.

Alternatively to changing (216) the contents of the IP source address field of packets received from server 108, in some embodiments of the invention, packets from server 108 are passed to client 106 with the server IP address provided by server 108. The client 106 will generally ignore the discrepancy between the IP address with which it sends packets to the server 108 and the IP address of the server in the packets received from the server.

In some embodiments of the invention, instead of forwarding the client request to server 108, CLB router 102 responds to the client with a message telling the client 106 to connect to the selected server 108. Optionally, the message comprises an HTTP redirection message, as is known in the art.

Although in the above description the determination of whether a packet matches an entry of translation table 122 is described as being based on specific field combinations, other field combinations may be used. For example, in some embodiments of the invention, identification is performed based only on client fields with or without the protocol field.

In some embodiments of the invention, CLB router 102 searches for connection termination packets and when these packets are received, the entry 302 of the connection is erased from translation table 122. Alternatively or additionally, entries which are not used for a predetermined time (e.g., 5-30 minutes, although substantially any other duration may be used) are erased from the table. Optionally, entries belonging to different clients 106 are erased after different amounts of time. For example, entries of low priority workers may be erased after short periods of no use, while entries of high priority workers remain for longer periods. In some embodiments of the invention, if table 122 is full when a new connection request is received, the request is rejected by the CLB router 102 and/or is forwarded through the CLB router 102 to a predetermined server 108 selected without relation to CLB considerations and/or without performing translations. Alternatively or additionally, the oldest entry in the table is removed in order to make room for the newly received request, optionally provided the oldest entry was not used for at least a predetermined amount of time.

In some embodiments of the invention, CLB router 102 comprises a single unit which is implemented in hardware, software or a combination thereof. Alternatively, CLB router 102 comprises a plurality of separate units, each of which performs a different portion of the tasks of the CLB router.

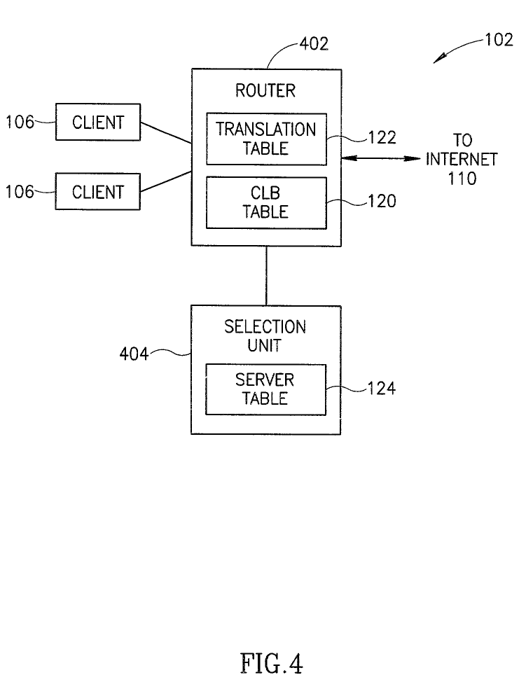

FIG. 4 is a simplified schematic block diagram of a CLB router 102, in accordance with an embodiment of the present invention. CLB router 102 optionally comprises, in this embodiment, a router 402 and a selection unit 404. Router 402 optionally identifies request packets which require CLB handling, using CLB table 120, and passes the packets to selection unit 404. Selection unit 404 determines which server 108 is to receive the request packet, using server table 124, changes the packet accordingly and transmits translation table configuration instructions to router 402. Router 402 manages translation table 122 and changes packets for which server selection was performed earlier. Optionally, packets that do not require CLB handling are handled solely by router 402 and are not passed to selection unit 404.

In some embodiments of the invention, selection unit 404 and router 402 are included in a single local area network and the communication between them is performed in layer 2. Alternatively, selection unit 404 and router 402 are included in different locations and the communication between them is performed in layer 3.

In the above embodiments, CLB router 102 operates transparently, such that no configuration of clients 106 is required. In some of these embodiments, clients 106 are not aware of the existence of CLB router 102. Furthermore, no changes are required to DNS server 112 and/or to servers 108.

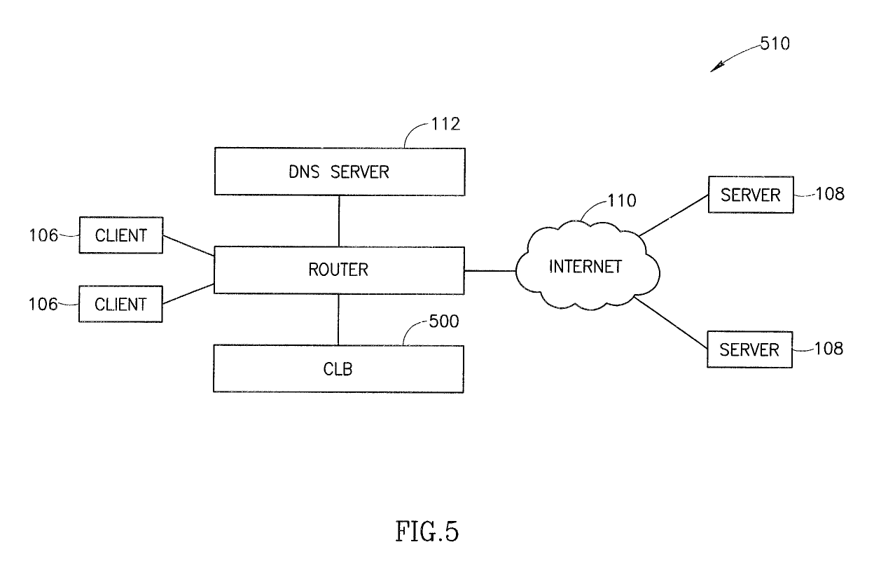

FIG. 5 is a schematic block diagram of a network 510 in which a client-controlled load balancer (CLB) 500 is used, in accordance with an alternative embodiment of the present invention. In the embodiment of FIG. 5, CLB 500 is not transparent, i.e., client 106 approaches CLB 500 when it is required to connect to a web site hosted by a plurality of geographically separated computers.

In some embodiments of the invention, client 106 is configured to approach CLB 500 for all accesses to web sites. CLB 500 optionally retrieves the contents of the web site for the client and returns the contents to the client. For web sites which require CLB handling, CLB 500 selects the server 108 to access according to CLB decisions, as described above with AD reference to FIG. 2. Alternatively, clients 106 are configured with a list of web sites for which CLB handling is desired, and for these web sites clients 106 approach CLB 500 rather than directly approaching the web site. The list of Web sites may be configured using any of the methods described above for configuring CLB table 120. Alternatively or additionally, clients 106 approach CLB 500 whenever they receive a plurality of IP addresses from DNS server 112.

In some embodiments of the invention, CLB 500 is implemented by DNS server 112. When a client 106 requests the IP address for a domain name (e.g., www.avaya.com) which is hosted by a plurality of servers 108, DNS server 112 selects a server 108 which is currently best for servicing the client 106. DNS server 112 then responds to client 106 with the IP address of the selected server. Optionally, DNS server 112 is located geographically close to client 106, such that the determination of which server 108 is best for the client may be performed based on the paths between the DNS server and servers 108, ignoring the distance between client 106 and the DNS server. Alternatively or additionally, the location of the client is taken into account in selecting the server 108. For example, if one or more clients 106 are located on different sides of DNS server 112 relative to servers 108, these differences may be taken into account in selecting a server 108 for the client 106. Optionally, DNS server 112 determines the position of client 106 based on its source IP address. Alternatively or additionally, the DNS protocol is extended to allow indication of the location of the client to the DNS server.

Alternatively to DNS server 112 performing the client-controlled load balancing, CLB 500 runs independently from the DNS server and updates the DNS server on the IP addresses to be used for sites receiving CLB handling. Optionally, CLB 500 manages a server table 124 as described above, and whenever there is a change in the server 108 to represent a site, an update message is transmitted to the DNS server 112.

Further alternatively to DNS server 112 performing the client-controlled load balancing, when DNS server 112 receives a query for a multi server web site, it consults a CLB 500 which selects one of the servers 108 hosting the web site. Optionally, DNS server 112 is configured to operate with a predetermined CLB 500. Alternatively or additionally, DNS server 112 selects a CLB 500 to consult, responsive to the location of client 106 and/or other load balancing criteria.

In some embodiments of the invention, DNS server 112 selects the CLB 500 closest to the client 106 generating the query. Optionally, DNS server 112 is configured with a list of 20 clients 106 closest to each CLB 500. Alternatively or additionally, DNS server 112 selects the CLB 500 according to the source IP address of the packet including the DNS query. Further alternatively or additionally, the DNS query includes an additional field which identifies the CLB closest to the client 106.

In some embodiments of the invention, CLB 500 selects a server 108 and transmits a response to the DNS query indicating the chosen server, directly to the client 106. Alternatively, CLB 500 responds to the DNS which sends the query response to the client.

Alternatively to client 106 receiving an IP address of a selected server 108 responsive to the DNS query it generates, DNS server 112 responds to the DNS query with the IP address of CLB 500. When the client 106 approaches CLB 500, CLB 500 selects a server 108 and connects client 106 to the selected server according to any of the above described methods. Such methods may include, for example, transparently changing the packets and forwarding them to the selected server and/or forming a separate connection to server 108. Optionally, CLB 500 determines the site to which the client requested to connect according to the Web address included in the application layer portions of the client packets. The CLB 500 optionally establishes a connection with the client before selecting the server 108 to represent the site, in order to receive the web address on the connection.

In some embodiments of the invention, the client-controlled load balancer (CLB) is implemented in a single unit with, and/or in coordination with, a proxy server. The combining of the operation of a CLB and a proxy provides enhanced Internet access for both frequently updated (e.g., real time) web pages and for static web pages. Alternatively or additionally, the client-controlled load balancer (CLB) is implemented together with a firewall and/or any other network apparatus. In an exemplary embodiment of the invention, a single load balancer is used as a server load balancer for traffic directed to a web site located in a LAN of a corporation, and is used as a client-controlled load balancer for traffic directed out of the LAN of the corporation.

In some embodiments of the invention, a plurality of client-controlled load balancers (CLBs) are used in a hierarchical structure. For example, a first CLB may select one of a plurality of ISPs to provide Internet access, and a second CLB managed by the selected ISP may select the server having a fastest path to the ISP. It is noted that although the above description relates to accessing web sites, the present invention is not limited to accessing web sites or to any specific protocol. The use of a CLB in accordance with the present invention may be advantageous, for example, for HTTP, FTP, HTTPS protocols, as well as other protocols and to access of other servers than web servers, such as FTP servers.

It will be appreciated that the above described methods may be varied in many ways, including, changing the order of steps, and/or performing a plurality of steps concurrently. For example, some or all of the tasks of the CLB may be performed by the client. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of selecting a server to represent a virtual server hosted by a plurality of servers, comprising:
providing, by a load balancer not associated with the virtual server, values, for one or more parameters, of two or more paths, each path defined between a point in a vicinity of a client accessing the virtual server and one of the plurality of servers representing the virtual server; and
selecting a server to provide data for the client, responsive to the values of the one or more parameters.

2. A method according to claim 1, wherein the load balancer and the client are in the same metropolitan area.

3. A method according to claim 1, wherein the load balancer and the client are in the same local area network.

4. A method according to claim 1, wherein the one or more parameters comprise at least one of a jitter, a round trip delay or a hop count.

5. A method according to claim 1, wherein the one or more parameters comprise a cost.

6. A method according to claim 1, wherein selecting the server comprises selecting, by a client-controlled load balancer, responsive to receiving identification of a virtual server requested by the client.

7. A method according to claim 6, wherein selecting the server comprises selecting, by a client-controlled load balancer, responsive to receiving a connection establishment request from the client.

8. A method according to claim 6, wherein providing the values for the one or more parameters comprises measuring at least one of the parameters.

9. A method according to claim 8, wherein measuring at least one of the parameters, for at least one of the paths, is performed before receiving the connection establishment request.

10. A method according to claim 8, wherein measuring at least one of the parameters for at least one of the paths is performed after receiving the connection establishment request.

11. A method according to claim 1, further comprising changing the destination IP address of packets received by the load balancer from the client, to an IP address of the selected server.

12. A method according to claim 1, further comprising changing the source IP address of packets received by the load balancer from the selected server.

13. A method according to claim 1, further comprising transmitting an IP address of the selected server to the client.

14. A method according to claim 13, wherein transmitting the IP address of the selected server to the client comprises transmitting a DNS response.

15. A method according to claim 1, wherein ones of the plurality of servers are located in different geographical regions.

16. A method according to claim 1, wherein selecting a server to provide data for the client comprises selecting, by the load balancer, a second load balancer which is to perform the server selection and selecting, by the second load balancer, a server to provide data for the client.

17. A method according to claim 1, wherein the virtual server hosts a web site.

18. A method according to claim 1, wherein selecting a server to provide data for the client comprises selecting a server which minimizes a function of the one or more parameters.

19. A method according to claim 18, wherein selecting a server to provide data comprises choosing a function of the one or more parameters to be minimized and selecting a server which minimizes the chosen function.

20. A method according to claim 19, wherein the function is chosen responsive to a protocol with which the virtual server is accessed.

21. A method according to claim 19, wherein the function is chosen responsive to the virtual server accessed.

22. A method according to claim 19, wherein the function is chosen responsive to an attribute of the client.

23. A method according to claim 19, wherein the function is chosen responsive to the time of the selection.

24. A method of selecting a server to be accessed, comprising:
receiving, by a load balancer, a message relating to a virtual server, hosted by a plurality of servers, and to a client desiring to receive data from the virtual server; and
selecting, by the load balancer, one of the plurality of servers to provide data to the server,
wherein the load balancer is closer to the client than to the selected server.

25. A method according to claim 24, wherein the load balancer is closer to the client than to any of the plurality of servers hosting the virtual server.

26. A method according to claim 24, wherein the load balancer is in the same metropolitan area as the client.

27. A method according to claim 24, wherein the load balancer is in the same local area network as the client.

28. A method according to claim 24, wherein the load balancer is not associated with the virtual server.

29. A method according to claim 24, wherein the load balancer is under control of a system manager of the client.

30. A method according to claim 24, wherein receiving the message comprises receiving a DNS query message.

31. A method according to claim 24, wherein receiving the message comprises receiving from a DNS server.

32. A method according to claim 24, wherein receiving the message comprises receiving a connection establishment request directed to the virtual server.

33. A method according to claim 24, wherein receiving the message comprises receiving a message directed to the load balancer.

34. A method according to claim 24, wherein selecting one of the servers comprises selecting a server which has a lowest cost path to the load balancer.

35. A method according to claim 24, wherein selecting one of the servers comprises selecting a server which has a lowest delay path or a highest packet size path to the load balancer.

36. A method according to claim 24, wherein the load balancer is geographically closer to the client than to the selected server.

37. A method of selecting a server to be accessed, comprising:
receiving, by a load balancer, a message relating to a virtual server, hosted by a plurality of servers, and to a client desiring to receive data from the virtual server; and
selecting, by the load balancer, one of the plurality of servers to provide data to the client, at least partially responsive to the cost of communications between the client and one or more of the plurality of servers.

38. A method according to claim 37, wherein selecting one of the servers comprises selecting a server under a constraint that a lowest cost client communication connection is used in connecting to the server.

39. A method according to claim 37, wherein selecting one of the servers comprises selecting a server which minimizes a weighted sum of communication costs to the server and at least one other route related parameter.

40. A method according to claim 39, wherein selecting one of the servers comprises selecting a server which minimizes a weighted sum of the communication costs to the server and the round trip delay to the server.

41. A load balancer, comprising:
an interface adapted to receive server access messages from clients; and
a processor adapted to determine, for at least one of the messages, whether the message requires load balancing responsive to at least one attribute different from the identity of the server referenced by the message, and to select for at least one message determined to require load balancing, a server to service the client.

42. A load balancer according to claim 41, wherein the at least one attribute comprises the time at which the message is received at the interface.

43. A load balancer according to claim 41, wherein the at least one attribute comprises the identity of the client.

44. A load balancer according to claim 41, wherein the at least one attribute comprises a protocol to govern the communication with the server.

45. A load balancer according to claim 41, further comprising a packet changing unit adapted to change the contents of at least one field of packets belonging to connections for which load balancing was performed.

46. A load balancer according to claim 41, wherein the packet changing unit is adapted to change packets in accordance with half NAT or full NAT procedures.

47. A method of selecting a server to be accessed, comprising:
receiving, by a load balancer, a message relating to a virtual server, hosted by a plurality of servers, and to a client desiring to receive data from the virtual server;
choosing a function from a plurality of predetermined functions utilized by the load balancer for selecting servers, responsive to the received message; and
selecting, by the load balancer, one of the plurality of servers that minimizes or maximizes the chosen function, to provide data to the client.

48. A method according to claim 47, wherein choosing the function comprises choosing responsive to an identity of the client.

49. A method according to claim 47, wherein choosing the function comprises choosing responsive to a time at which the message is received.

50. A method according to claim 47, wherein at least two of the predetermined functions depend on different groups of one or more parameters.

51. A method according to claim 47, wherein at least two of the predetermined functions depend on the same parameters but give different weight to one or more of the parameters on which they depend.
